(19) United States
(12) Patent Application Publication
(10) Pub. No.: US 2007/0043111 A1
(43) Pub. Date: Feb. 22, 2007

(54) Use of ifenprodril in the treatment of pain

(76) Inventors: John Brew, Essex (GB); Robin Mark Bannister, Essex (GB); Andrew Douglas Baxter, Essex (GB); Alan Rothaul, Essex (GB); Michael Harvey Lyne, Essex (GB)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 10/575,912

(22) PCT Filed: Oct. 21, 2004
(86) PCT No.: PCT/GB04/04459

§ 371 Date: Nov. 7, 2006

(30) Foreign Application Priority Data
Oct. 21, 2003 (GB) 0321583.4
Jul. 7, 2004 (GB) 0415267.4

(51) Int. Cl. A01N 37/00

(52) U.S. Cl. 514/510

(57) ABSTRACT

Ifenprodil is useful for the treatment of pain.

This application is a National Stage Application of International Application Number PCT/GB2004/004459, filled Oct. 21, 2004; which claims priority to British Application Nos. 0324583.4, filed Oct. 21, 2003, and 0415267.4, filed Jul. 7, 2004.

### FIELD OF THE INVENTION

This invention relates to the use of a known compound for the treatment of pain.

### BACKGROUND OF THE INVENTION

N-methyl-D-aspartate (NMDA) receptor antagonists have been long known to exhibit anti-nociceptive effects, and a number have proven efficacy in the treatment of a number of neuropathies, including postherpetic neuralgia, central pain caused by spinal cord injury and phantom limb pain. The NMDA receptor antagonist dextrorphan is disclosed for the treatment of pain in EP-A-0615749 and also, along with a number of other such compounds (including ifenprodil), in WO-A-97/14415. Unfortunately, most agents which block the NMDA receptor also induce unacceptable side-effects at analgesic doses, including memory impairment, ataxia, hallucinations and dysphoria, which prohibit their widespread use.

Ifenprodil, i.e. 2-(4-benzylpiperidino)-1-(4-hydroxyphenyl)-1-propanol, selectively blocks NR2B-containing NMDA receptors in a voltage-independent and non-competitive manner (Gallagher et al., 1996, J. Biol. Chem. 271(16):9603-9611) and exhibits anti-nociceptive activity in animal models of acute and chronic pain (Taniguchi et al., 1997, Brit. J. Pharmacol. 122, 809-812; Boyce et al., 1999, Neuropharmacology 38:611-623). Ifenprodil (as ifenprodil tartrate) is commercially available as a racemic mixture of the erythro diastereomer.

Ifenprodil also exhibits potent alpha-1 adrenergic receptor binding properties (Chenard et al., 1991, J. Med. Chem. 34 (10):3085-3090) which can cause hypotension and syncope in some recipients. It is also reported by Chenard et al. that the threo isomers of ifenprodil have selectivity for the NMDA receptor over the alpha-1 adrenoreceptor.

WO03/092689 describes the utility of ifenprodil in the treatment of neuropathic pain. Intranasal administration (and other route, preferably avoiding first-pass metabolism) are described.

### SUMMARY OF THE INVENTION

The present invention is based on the discovery that ifenprodil has utility in the treatment of pain, especially non-neuropathic pain conditions, including post-operative pain, acute pain, chronic benign and cancer pain. Accordingly, ifenprodil can be used to boost analgesia during intermittently uncontrollable episodes (breakthroughs) found in certain painful conditions, e.g. the conditions known as episodic or breakthrough pain. These conditions include chronic benign pain and cancer pain. The chronic benign pain states can be categorised as musculoskeletal, visceral, and headache pain and include conditions such as osteoarthritis, chronic pancreatitis, and chronic migraine. Cancer pain conditions are associated with the malignant growth of tumours both primary and metastatic in nature. The condition is thought to be associated with either pressure on normal tissue (invasion) or by the release of pro-nociceptive mediators in and around the tumour. Pain conditions to be treated include also those associated with inflammation, e.g. as in osteoarthritis.

### DESCRIPTION OF PREFERRED EMBODIMENTS

Ifenprodil has two chiral centres. Any reference herein to ifenprodil should be understood as a reference to any enantiomer or mixture thereof. Any enantiomer may be substantially free of others, e.g. in an enantiomeric excess of at least 80%, preferably at least 90% and more preferably at least 95%. Similarly, any mixture of diastereomers may be substantially free of the other. The threo form, and in particular the (−)-threo form, may be preferred in certain cases; the (−)-erythro form may be preferred in others.

The ifenprodil may be in the form of the free base or any pharmaceutically acceptable salt, e.g. the citrate or tartrate, or in the form of a metabolite or prodrug. Such forms are known to those of ordinary skill in the art.

The active agent may be administered by, for example, the oral, topical, dermal, ocular, intravenous, intraarticular, rectal, vaginal, inhalation, intranasal, sublingual or buccal route. The amount of active ingredient that is used can be chosen by the skilled person having regard to the usual factors.

For use, the active agent is typically formulated, e.g. with a conventional diluent or carrier, or as a patch, as a medicament adapted to be delivered by the chosen route. Such formulations are known to those skilled in the art, and will be chosen according to the usual considerations such as the potency of the drug, the severity of the condition and the route of administration.

Ifenprodil is preferably administered sublingually, intranasally, buccally or by the pulmonary or any other route that avoids first-pass metabolism. Sublingual or nasal delivery, for example, can introduce significant concentrations of ifenprodil and its isomers to NMDA receptors whilst reducing side-effects caused by the unwanted alpha-1 adrenoreceptor-binding activity. In this context, a typical daily dose is less than 60 mg, e.g. 1 to 50 mg, ifenprodil; a higher dose, e.g. up to 500 mg, may be used, especially if first-pass metabolism is not avoided.

In particular, it would be of benefit to administer ifenprodil in a manner that reduced peripheral exposure to vascular smooth muscle (minimise effect on vascular tone), while maximising the concentrations in the CNS (maximise analgesia). This may be done by, for example, pulmonary, sublingual or nasal delivery, reducing systemic load, while maximising the concentration of drug in the CNS. By way of example only, a composition for intranasal delivery comprises, in addition to ifenprodil, one or more of a solubility enhancer such as propylene glycol, a humectant such as mannitol, a buffer and water. A mucoadhesive agent may also be used.

Ifenprodil has very poor pharmacokinetics, with very high first-pass metabolism (5% bioavailability and a short half life; t_{1/2} 1 hour). Consequently, administering ifenprodil orally, to treat a chronic condition like neuropathic pain, may require high and frequent doses. Dermal administration, e.g. by the use of a dermal patch, allows chronic dosing of this compound, while avoiding first-pass metabolism and so lowering the dose. Additionally, there is the potential of removing the dose from the circulation rapidly at the end of the treatment period.

Another preferred route of administration is sublingual. A suitable formulation for this purpose may contain components known to those skilled in the art.

It will often be advantageous to use ifenprodil in combination with another drug used for pain therapy. Such another drug may be an opiate or a non-opiate such as baclofen.

The following Examples illustrate the invention.

### EXAMPLE 1

This Example is of a composition suitable for intranasal delivery. In this Example, 1-10 mg ifenprodil, preferably as (−)-threo-ifenprodil citrate, is included in 100 μl of:

Excipient: % w/w

Benzalkonium chloride 0.02 Preservative

Propylene Glycol 25 Solubility Enhancer

Mannitol 15 Humectant

Na₂PO₄ (0.2M) 25.2

Citric Acid (0.1 M) 10.0

Deionised water 24.6 (pH6.5 buffer)

### EXAMPLE 2

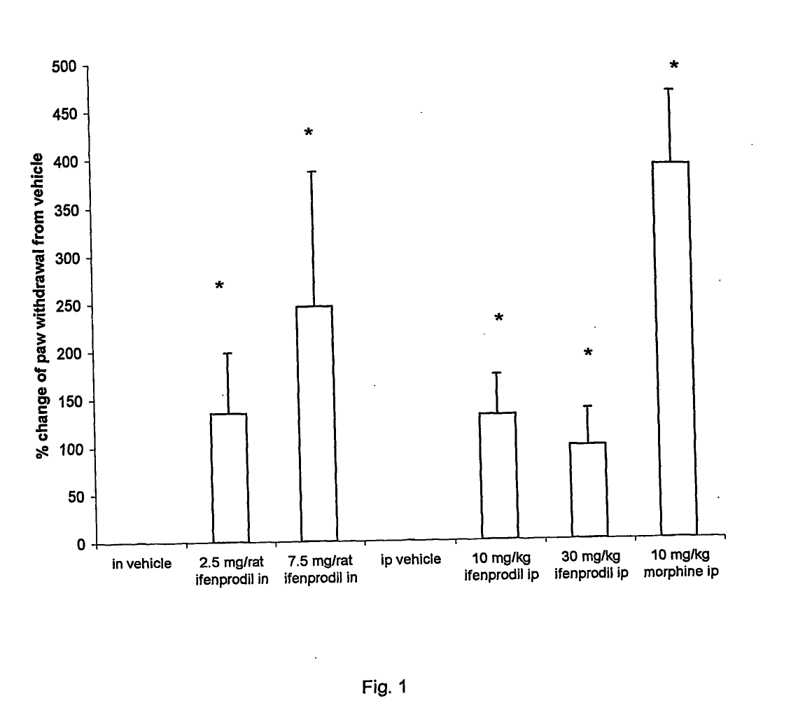

In a test on the effect of ifenprodil on the intraplantar carrageenan-induced paw withdrawal latency in the rat, the erythro racemate of ifenprodil was demonstrated to be markedly analgesic when administered via both the intraperitoneal (10 mg/kg and 30 mg/kg) and the intranasal route (2.5 mg/rat and 7.5 mg/rat); see FIG. 1. The intranasal route proved to be at least equivalent if not superior to the intraperitoneal route.

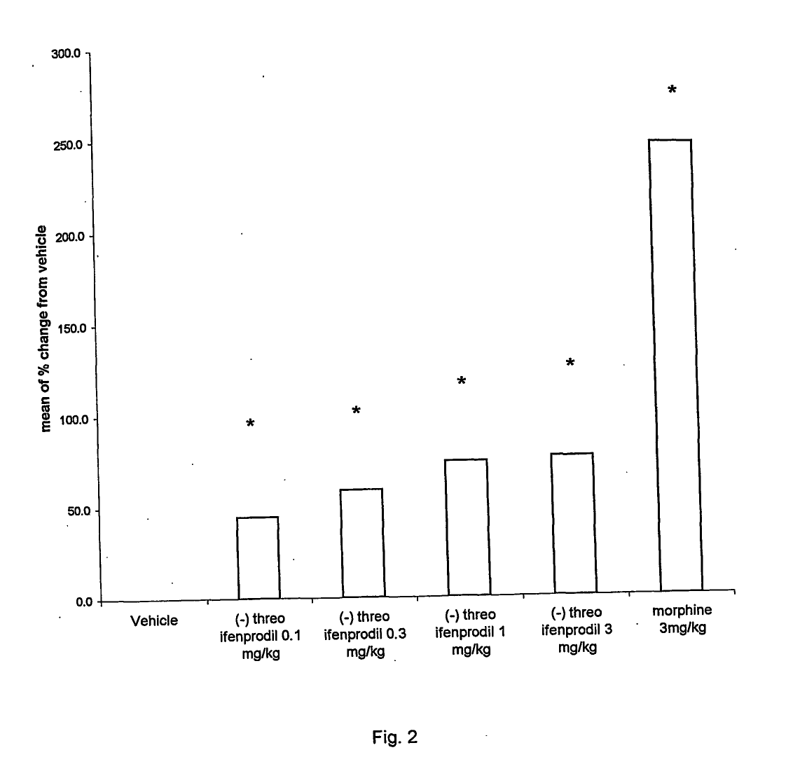

(−) Threo-ifenprodil has also been demonstrated to have excellent efficacy in the intraplantar carrageenan-induced paw withdrawal latency in the rat at low doses (0.1, 0.3, 1 and 3 mg/kg intravenous); see FIG. 2. These results indicate that (−) threo-ifenprodil, when given through the nasal route, will have excellent efficacy in this pain model and in chronic pain conditions.

More particularly, FIG. 1 is a graph showing the effect of (−) threo-ifenprodil when given intranasally or intraperitoneally at 10 and 30 mg/kg on the % change of pressure-induced paw withdrawal latency on the intraplantar carrageenan administered paw in the rat (250 g).

FIG. 2 is a graph showing the effect of (−) threo-ifenprodil when given intravenously at 0.1 to 3 mg/kg on the % change of pressure-induced paw withdrawal latency on the intraplantar carrageenan administered paw in the rat.

1. A method for the treatment of pain wherein said method comprises the administration of ifenprodil to a patient in need of such treatment.

2. The method according to claim 1, for the treatment of intermittent or episodic pain experienced by a patient undergoing chronic pain treatment.

3. The method according to claim 1, wherein the pain is chronic benign pain.

4. The method according to claim 3, wherein the pain is related to a musculoskeletal, visceral or headache condition.

5. The method according to claim 4, wherein the condition is osteoarthritis, chronic pancreatitis or chronic migraine.

6. The method according to claim 2, wherein the pain is episodic or breakthrough pain in cancer.

7. The method according to claim 1, wherein the pain is acute pain.

8. The method according to claim 1, wherein the pain is post-operative pain.

9. The method according to claim 1, wherein the ifenprodil is in the form of either or both threo enantiomers.

10. The method according to claim 9, wherein the ifenprodil is (−)-threo-ifenprodil.

11. The method according to claim 1, where the administration is done via a route that avoids first-pass metabolism.

12. The method according to claim 11, wherein the route is sublingual.

13. The method according to claim 11, wherein the route is intranasal.

14. The method according to claim 11, wherein the route is dermal.

15. The method according to claim 11, wherein the ifenprodil is in the form of a unit dosage containing less than 60 mg ifenprodil.

16. A composition suitable for intranasal delivery, which comprises an aqueous solution of ifenprodil, a solubility enhancer and a humectant.

17. The composition according to claim 16, wherein the ifenprodil is (−)-threo-ifenprodil.

18. The composition according to claim 17, wherein the ifenprodil is (−)-erythro-ifenprodil.
